(19) United States
(12) Patent Application Publication
(10) Pub. No.: US 2006/0032272 A1
(43) Pub. Date: Feb. 16, 2006

(54) Spacer backing winder for use with a supplied work product

(75) Inventor: William J. Hamilton, Concord, OH (US)

Correspondence Address: PEARNE & GORDON LLP, 1801 EAST 9TH STREET, SUITE 1200, CLEVELAND, OH, 44114-3108, US

(73) Assignee: Besten, Inc., Cleveland, OH (US)

(21) Appl. No.: 10/915,275

(22) Filed: Aug. 10, 2004

(51) Int. Cl. C03B 23/00; C03B 29/00; C03B 21/00; C03B 25/00; C03B 27/00; C03B 31/00; C03B 33/00

(52) U.S. Cl. 65/102

(57) ABSTRACT

A device for supplying a work product and collecting a length of waste backing sheet byproduct during a manufacturing process for making windows, the work product having the waste backing sheet releasably attached thereto to prevent inadvertent adhesion.

### FIELD OF THE INVENTION

The present invention relates to the field of collecting a waste backing sheet as a wound work product is supplied, and more particularly, to a spacer backing winder for collecting a length of waste backing sheet during a manufacturing process for making windows.

### BACKGROUND OF THE INVENTION

Double pane windows, which are commonly used within homes and other structures, include an insulative air gap between two panes of glass. One of the difficulties in the manufacture of double pane windows is maintaining a uniform gap between the two panes of glass while providing a tight seal between the interior air gap and the outside environment. During the manufacture of such windows, it is commonly known to affix a work product, such as a flexible spacer, between two panes of glass containing its own sealant and desiccant. Generally, the flexible spacer is approximately 0.25 inches to approximately 1 inch thick and is supplied to the manufacturing process on supply reels containing approximately 1000 linear feet to approximately 2000 linear feet.

The flexible spacer also has an adhesive layer on opposite sides such that the spacer can be affixed to both panes of glass. Consequently, the spacer must have a waste backing sheet releasably attached to one side to prevent inadvertent adhesion while the spacer is contained on the supply reel. Upon use of the flexible spacer, the waste backing sheet is peeled away and discarded as a byproduct. Multiple rolls of flexible spacer material may be used during a common manufacturing day, resulting in many thousands of feet of unwanted waste backing sheet byproduct per day. The large amount of unwanted waste backing sheet byproduct creates a nuisance and a safety hazard to workers in a manufacturing facility. Therefore, there is a need for a spacer backing winder.

One attempt to collect the unwanted waste backing sheet byproduct has been to attach a pinch winder to a 55-gallon drum to guide the waste backing sheet byproduct into the drum. Such a system is prone to jamming, and requires a worker to constantly monitor the drum to ensure that it does not overflow. When the drum overflows, a worker is required to manually compact the waste backing sheet into the drum to create space to allow more to be admitted. This is time consuming, and may require the window manufacturing process to be temporarily stopped to correct the problem. If a worker does not monitor the drum, excess waste backing sheet will spill from the drum and create a nuisance and a safety hazard in the manufacturing environment. Accordingly, there is a need for an improved spacer backing winder.

### SUMMARY OF THE INVENTION

It is the object of the invention to provide a device for supplying an adhesive work product for use in making windows and collecting a waste backing sheet byproduct. The device includes a support arrangement and at least one supply reel for supplying the work product to a manufacturing process for making windows, the supply reel being rotatably supported on the support arrangement for rotation about a first axis, the work product having the waste backing sheet releasably attached thereto to prevent inadvertent adhesion while on the supply reel. The device also includes a take-up reel for collecting the waste backing sheet, the take-up reel being rotatably supported on the support arrangement for rotation about a second axis that is parallel to the first axis, rotation means activatable for causing the take-up reel to rotate and collect the waste backing sheet, and means for activating the rotation means when tension is maintained on the work product during supply of the work product.

It is a further object of the invention to provide a method for supplying a work product and collecting a waste backing sheet byproduct. The method comprises the steps of: (1) providing a support arrangement; (2) providing at least one supply reel for supplying the work product to a manufacturing process for making windows, the supply reel being rotatably supported on the support arrangement for rotation about a first axis, the work product having the waste backing sheet releasably attached thereto to prevent inadvertent adhesion while on the supply reel; (3) maintaining tension in a longitudinal direction on the work product during supply of the work product; (4) utilizing means for detecting tension in the work product; (5) utilizing means for activating the motor means when tension is detected on the work product; (6) causing the motor means to rotate for driving a drive roll shaft; (7) causing the drive roll shaft to rotate for driving a takeup reel resting partially thereon, wherein the takeup reel has a second rotational axis that is parallel to the first rotational axis; and (8) rotating the takeup reel for collecting the waste backing sheet from the supply reel.

### BRIEF DESCRIPTION OF THE DRAWINGS

FIG. 1 is a schematic, perspective view of a spacer backing winder according to an embodiment of the present invention.

FIG. 2 is a schematic side view of the spacer backing winder of FIG. 1.

FIG. 3 is a schematic front view of the spacer backing winder of FIG. 1 and shows a phantom representation indicating use with a different reel.

### DESCRIPTION OF AN EXAMPLE EMBODIMENT

It will be apparent to those skilled in the art, that is, to those who have knowledge or experience in this area of technology, that many uses and design variations are possible for the improved spacer backing winder disclosed herein. The following discussion will illustrate the general principles of the invention with reference to a spacer backing winder for use in a manufacturing process for making windows. However, the following discussion should not be considered a limitation on the scope of the present invention. Other embodiments, modifications, improvements, etc., will be apparent to those skilled in the art given the benefit of this disclosure. Such other embodiments, modifications, improvements, etc., are to be considered part of the present invention.

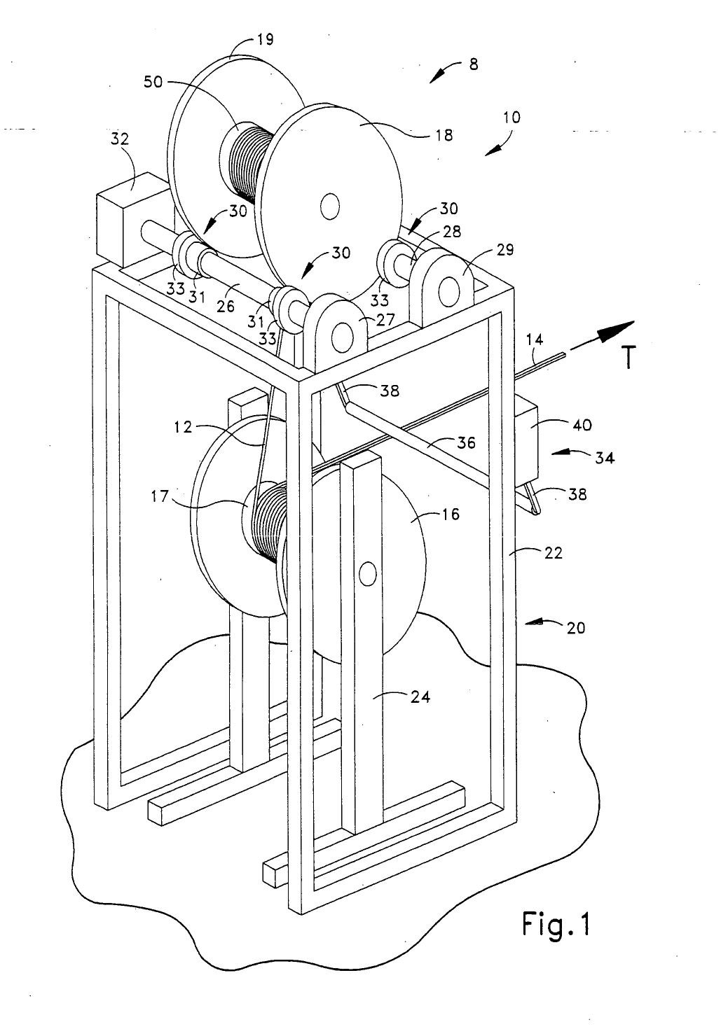

Referring now to the drawings, FIG. 1 shows a device 8 that includes an example spacer backing winder 10 for collecting a length of waste backing sheet 12 onto a takeup reel 18 from a supply reel 16 according to the teachings of the invention. While on the supply reel 16, the work product 14 has a length of waste backing sheet 12 releasably attached thereto to prevent inadvertent adhesion. The drawings show only a single layer of wind on the supply reel 16 and takeup reel 18. It is to be appreciated that multiple layers of wind are possible on both the supply reel 16 and takeup reel 18. It is further to be appreciated that other flexible glass spacer seals may also be used with the present invention.

The spacer backing winder 10 is supported by a support arrangement 20. The support arrangement 20 consists of at least one frame, and it is to be appreciated that the support arrangement may consist of multiple frames. As shown in the example depicted in FIG. 1, the support arrangement 20 consists of two frames 22, 24. The supply reel 16 is supported on a frame 24 and contains a length of work product 14 wound around a central hub 17. Alternatively, a carousel assembly (not shown) adapted to support a first supply reel over a second supply reel and to rotate about a fixed axis defined between the first and second rolls may also be used.

In order to support the takeup reel 18, a drive roll shaft 26 and an idler roll shaft 28 are rotatably supported on the support arrangement 20. As shown in the example depicted in FIG. 1, the drive roll shaft 26 and idler roll shaft 28 are supported on the frame 22 by roller bearings 27, 29. It is to be appreciated that any other rotatable support may also be used with the present invention.

In the example depicted in FIG. 1, the roll shafts 26, 28 are located at a position above the supply reel 16. However, other locations are contemplated. The roll shafts 26, 28 are situated in a parallel fashion relative to each another such that the takeup reel 18 is supported in the space between the rolls 26, 28. The drive roll shaft 26 and idler roll shaft 28 are spaced apart such that the takeup reel 18 is held in place between the roll shafts 26, 28 by the force of gravity. It is to be appreciated that the roll shafts 26, 28 can be positioned in any manner that allows the takeup reel 18 to be supported therebetween.

Turning briefly to FIG. 3, the supply reel 16 has a first rotational axis 42 and the takeup reel 18 has a second rotational axis 44. The takeup reel 18 is held in place between the roll shafts 26, 28 in a manner such that the second rotational axis 44 is parallel to the first rotational axis 42.

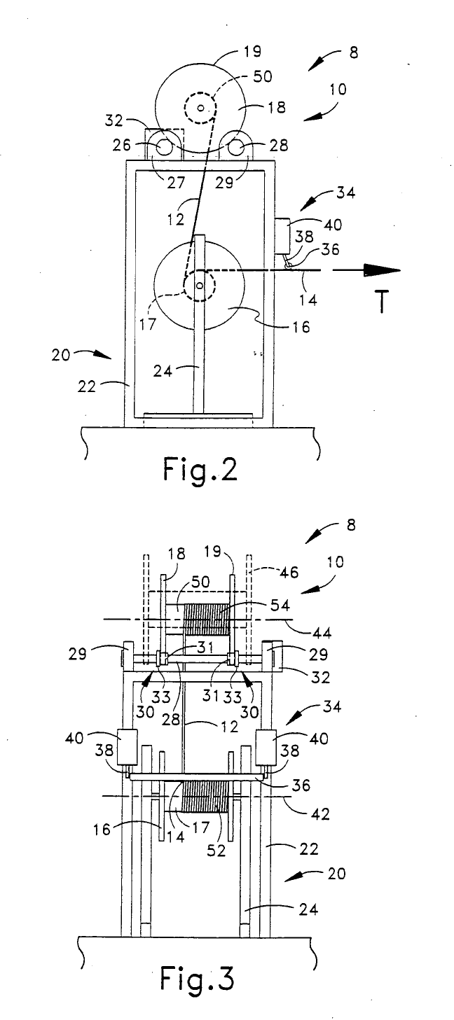

Referring back to FIG. 1, a plurality of reel guides 30 are mounted to the roll shafts 26, 28 and are positioned in such a manner so as to contact the outer periphery 19 of the takeup reel 18. It is to be appreciated that the reel guides 30 are not shown in FIG. 2 for clarity. Any number of reel guides 30 may be mounted to the roll shafts 26, 28 in order to facilitate the interchangeability of the same or different size takeup reel 18. As such, it is to be appreciated that an alternate takeup reel 46 (shown in phantom, FIG. 3) may be used that differs in diameter, length, or both, from the takeup reel 18 (shown in solid).

In the example shown in FIG. 1, the reel guides 30 are constructed as an assembly including a friction engagement surface 31 that provides a frictional surface for driving the takeup reel 18, and a spacer guide 33 for preventing axial movement of the takeup reel 18. However, it is to be appreciated that a reel guide 30 may be formed as a single structure. The friction engagement surface 31 is fixed to the spacer guide 33 by a set screw (not shown) to form a reel guide 30. The assembled reel guides 30 are each fixed in place on the roll shafts 26, 28 by a set screw (not shown). In the present example, the friction engagement surface 31 is formed as a hollow cylinder and is made of a plastic material, such as polyvinyl chloride, that provides a frictional surface against which a tangential force for driving the takeup reel 18 is transmitted from the drive roll shaft 26 to the outer periphery 19 of the takeup reel 18. It is to be appreciated that any other frictional material or frictional surface may be used instead of plastic. The spacer guide 33 is made of a strong and durable material, such as aluminum, steel, hard plastic or hard rubber, and includes an annular flange that may contact an outer surface of the takeup reel 18 to prevent axial movement of the takeup reel 18.

A motor means 32 is engaged to the drive roll shaft 26 using any known method and causes the drive roll shaft 26 to rotate. In the example shown in FIG.1, the motor 32 consists of an air motor that operates on pneumatic power from a source (not shown). It is to be appreciated that any type of motor or engine, for example an electric motor, hydraulic motor or a gas engine, may be used in place of an air motor. It is to be further appreciated that the motor may, as shown in FIG. 1, or may not (not shown), act as a rotatable support for an end of the drive roll shaft 26.

Turning now to FIGS. 2 and 3, a means for activating 34 the motor means 32 is supported on the support arrangement 10. In the example shown in FIG. 3, the means for activating 34 consists of a counter weighted contact bar 36 that is supported on a frame 22 by swing arms 38 connected to a switch 40. The swing arms 38 are fixed at one end to the contact bar 36 and are rotatably connected to the switch 40 at the other end. The switch 40 is triggered when the swing arms 38 rotate in an accurate manner. In the example shown in FIG. 2, the switch 40 is triggered to an “on” position when the swing arms 38 rotate in a counter-clockwise fashion, and to an “off” position when the swing arms 38 rotate in a clockwise fashion. The rotatable connection between the swing arms 38 and the switch 40 is spring-loaded such that when the swing arms 38 and contact bar 36 are at rest, the switch 40 is maintained in the “off” position. It is to be appreciated that any other means for activating 34 the motor means 32, for example a spring-loaded contact bar, a simple electric switch, an electric stepper motor, or pneumatic pressure and flow control valve, may be used instead of a counter weighted contact bar 36.

For use of the present embodiment, an initial length of waste backing sheet 12 is manually detached from the work product 14 and caused to be secured by any suitable method to a central hub 50 of the takeup reel 18 or waste backing sheet already wound thereon. The spacer backing winder 10 is caused to operate only during supply of the work product 14 to a manufacturing process. During supply of the work product 14, a tension T is maintained in a longitudinal direction on the work product 14. The tension T causes the work product 14 to become taught and thereby substantially eliminate any slack in the work product 14. In the example shown in FIG. 2, the taught work product 14 contacts the contact bar 36 of the means for activating 34 and causes the contact bar 36 to be vertically displaced upward. The vertical displacement of the contact bar 36 causes the swing arms 38 to rotate in a counter-clockwise fashion, thereby triggering the switch 40 to an “on” position. Consequently, the means for activating 34 may also function as a means for detecting tension in the work product 14.

When the switch 40 is triggered to an “on” position, the motor means 32 is caused to rotate. In turn, the drive roll shaft 26 is driven by the motor means 32 and caused to rotate. As a result, the drive roll shaft 26 causes the takeup reel 18 to rotate. Thus, the tension T imparted into the work product 14 during supply of the work product 14 ultimately results in causing the takeup reel 18 to rotate. When the work product 14 is no longer supplied, slack is reintroduced into the work product 14 thereby substantially eliminating the tension T. In turn, the switch returns to an “off” position and the takeup reel 18 ultimately ceases to rotate.

During supply of the work product 14, the tension T imparted therein causes a length of the work product 14 to unwind from the central hub 17 of the supply reel 16. Thereafter, in the example shown in FIG. 2, as the work product 14 is unwound from the supply reel 16 and the tension imparted therein ultimately causes the takeup reel 18 to rotate, a substantially equal length of waste backing sheet 12 will automatically and continuously detach itself from the work product 14 and be wound around the central hub 50 of the takeup reel 18. When the work product 14 is no longer supplied, the length of waste backing sheet 12 will cease to detach itself from the work product 14 and cease to wind itself around the takeup reel 18.

Generally, the thickness of the waste backing sheet 12 is less than that of the work product 14. Consequently, the takeup reel 18 will fill at a slower rate than the supply reel 16 will empty. Replacement of the takeup reel 18 is independent of the supply reel 16 and need only be performed when it is full or otherwise desired.

In the example shown in FIG. 3, the work product 14 is wound around the central hub 17 of the supply reel 16 in a level-wind fashion 52. That is, the work product 14 is wound in a continuous spiral fashion extending along the full length of the central hub 17 with the spiral periodically reversing axial direction. The level-wind winding of the work product 14 may also include multiple layers. Because the first rotational axis 42 of the supply reel 16 is parallel to the second rotational axis 44 of the takeup reel 18, the waste backing sheet 12 is caused to similarly wind around the central hub 50 of the takeup reel 18 in a level-wind fashion 54. The level-wind winding of the waste backing sheet 12 may also include multiple layers. The level-wind winding of the waste backing sheet 12 on the takeup reel 18 is advantageous because it ensures that the maximum amount of waste backing sheet 12 is wound onto the takeup reel 18 by discouraging uneven distribution. It is to be appreciated that alternative methods of winding the work product 14 onto the supply reel 16 and the waste backing sheet 12 onto the takeup reel 18 may also be used.

It is to be understood that the invention has been described with regard to certain example embodiments. It is to be appreciated that certain modifications, changes, adaptations, etc., are contemplated and considered within the scope of the appended claims.

What is claimed is:

1. A device for supplying an adhesive work product for use in making windows and collecting a waste backing sheet byproduct, the device comprising:
a support arrangement;
at least one supply reel for supplying the work product to a manufacturing process for making windows, the supply reel being rotatably supported on the support arrangement for rotation about a first axis, the work product having the waste backing sheet releasably attached thereto to prevent inadvertent adhesion while on the supply reel;
a take-up reel for collecting the waste backing sheet, the take-up reel being rotatably supported on the support arrangement for rotation about a second axis that is parallel to the first axis;
rotation means activatable for causing the take-up reel to rotate and collect the waste backing sheet; and
means for activating the rotation means when tension is maintained on the work product during supply of the work product.

2. The device of claim 1, wherein the means for activating the rotation means comprises a counter weighted contact bar.

3. The device of claim 1, wherein the device is adapted to support a supply reel and a takeup reel each having varying diameters, lengths, or both.

4. The device of claim 1, wherein the supply reel further comprises a carousel assembly for supporting a first supply reel over a second supply reel in a first position and to rotate the assembly about a rotational axis defined between the first and second supply reels to a second position, wherein each of the first and second supply reels contains work product for a manufacturing process having releasable waste product attached thereto to prevent inadvertent adhesion.

5. The device of claim 1, wherein the waste backing sheet is collected on the takeup reel in a level-wind fashion.

6. A device for supplying an adhesive work product for use in making windows and collecting a waste backing sheet byproduct, comprising:
a support arrangement;
at least one supply reel for supplying the work product to a manufacturing process for making the windows, the supply reel being rotatably supported on the support arrangement for rotation about a first axis, the work product having the waste backing sheet releasably attached thereto to prevent inadvertent adhesion while on the supply reel;
an idler roll shaft rotatably supported on the support arrangement;
a drive roll shaft rotatably supported on the support arrangement;
motor means for driving the drive roll shaft;
a takeup reel for collecting the waste backing sheet, the takeup reel being rotatably supported by the idler roll shaft and the drive roll shaft for rotation about a second rotational axis that is parallel to the first rotational axis; and
means for activating the motor means when tension is maintained on the work product during supply of the work product.

7. The device of claim 6, further comprising means for preventing axial movement of the takeup reel.

8. The means of claim 7, wherein the means for preventing axial movement comprises a spacer guide having an annular flange.

9. The device of claim 6, further comprising a friction engagement surface contacting the outer periphery of the takeup reel.

10. The device of claim 6, further comprising a reel guide having a first portion comprising means for providing a rotational movement to the takeup reel and a second portion comprising a friction engagement surface contacting the outer periphery of the takeup reel.

11. The device of claim 8, wherein the takeup reel is supported on the friction engagement surface and is held in place by gravity.

12. The device of claim 6, wherein the means for activating the motor means comprises a counter weighted contact bar.

13. The device of claim 6, wherein the device is adapted to support a supply reel and a takeup reel each having varying diameters, lengths, or both.

14. The device of claim 6, wherein the supply reel further comprises a carousel assembly for supporting a first supply reel over a second supply reel in a first position and to rotate the assembly about a rotational axis defined between the first and second supply reels to a second position, wherein each of the first and second supply reels contains work product for a manufacturing process having releasable waste product attached thereto to prevent inadvertent adhesion.

15. The device of claim 6, wherein the waste backing sheet is collected on the takeup reel in a level-wind fashion.

16. A method for supplying a work product and collecting a waste backing sheet byproduct, comprising the steps of:
providing a support arrangement;
providing at least one supply reel for supplying the work product to a manufacturing process for making windows, the supply reel being rotatably supported on the support arrangement for rotation about a first axis, the work product having the waste backing sheet releasably attached thereto to prevent inadvertent adhesion while on the supply reel;
maintaining tension in a longitudinal direction on the work product during supply of the work product;
utilizing means for detecting tension in the work product; utilizing means for activating the motor means when tension is detected on the work product;
causing the motor means to rotate for driving a drive roll shaft;
causing the drive roll shaft to rotate for driving a takeup reel resting partially thereon, wherein the takeup reel has a second rotational axis that is parallel to the first rotational axis; and
rotating the takeup reel for collecting the waste backing sheet from the supply reel.

17. The method of claim 16, wherein the means for detecting tension in the work product comprises a counter weighted contact bar.

18. The method of claim 17, wherein the means for activating the motor means comprises a switch connected to the counter weighted contact bar.

19. The method of claim 16, wherein the support arrangement is adapted to support a supply reel and a takeup reel each having varying diameters, lengths, or both.

20. The method of claim 16, wherein the supply reel further comprises a carousel assembly for supporting a first supply reel over a second supply reel in a first position and to rotate the assembly about a rotational axis defined between the first and second supply reels to a second position, wherein each of the first and second supply reels contains work product for a manufacturing process having releasable waste product attached thereto to prevent inadvertent adhesion.

21. The method of claim 16, wherein the waste backing sheet is collected on the takeup reel in a level-wind fashion.

22. The method of claim 16, further comprising the step of replacing a takeup reel when it is full with an empty takeup reel.
